(19) United States
(12) Patent Application Publication
(10) Pub. No.: US 2010/0068351 A1
(43) Pub. Date: Mar. 18, 2010

(54) NEW PRODUCTS WITH A DAIRY MILK FILLING AND A GEL COATING

(76) Inventor: Corina ROTH, BREUBERG (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/517,596

(22) PCT Filed: Dec. 4, 2007
(86) PCT No.: PCT/EP2007/063233

§ 371 Date: Jun. 4, 2009

(30) Foreign Application Priority Data
Dec. 5, 2006 (EP) 06291879.2

(51) Int. Cl. A23L 1/05; A23L 1/0562; A23L 1/0532; A23P 1/08; A23C 9/154

(52) U.S. Cl. 426/102; 426/89; 426/512

(57) ABSTRACT

The present invention relates to a fresh food product in a 3-D form comprising a temperature-dependent jellified coating with a dairy product inside and to the process of manufacturing that food product. In particular the invention provides a fresh food product comprising a temperature-dependent external jellified coating and an internal filling comprising a dairy product which is completely enclosed in the external jellified coating, and the process for the manufacture of this product.

The present invention relates to a fresh food product in a 3-D form comprising a temperature-dependent jellified coating with a dairy product inside and to the process of manufacturing that food product.

In view of the large amount of dairy products consumed by consumers, there is always an interest in providing new, different and fancy fresh dairy products. Moreover, dairy products are known to be good for the health of consumers, especially children. Thanks to the calcium contained in such products, there is an interest to find new and attractive formulations of fresh dairy products, to incite them to eat more dairy products.

The present invention provides such a new shape of fresh dairy products. Furthermore, it is interesting to manufacture this product by a single step short time process such as the One-Shot technology (co-injection in a preformed mould).

The One shot technology is already known in confectionary industries (U.S. Pat. No. 4,517,205). However such a technology has never been used to produce dairy product coated by a gel. In fact it is difficult to formulate the gel in order to avoid that the final dairy product is glued to the mould which would prevent it from being demoulded.

Dairy product having a jellified coating are already known (DE 21 18 093, EP 0 429 817, U.S. Pat. No. 2,191,352, WO 01/30175 and JP 01 016556). However these products are not fresh dairy product but frozen dairy product. Therefore their processes of preparation are easier since the internal dairy product is in the solid form during the process.

U.S. Pat. No. 6,627,236 describes fresh dairy capsules containing a coating including food polymer reactive to multivalent ions inside which is confined dairy products. However in order to jellify the coating and stabilize the outside of the gel, it is necessary to use a calcium chloride solution or another outside source of calcium ions. As a consequence the capsule can only have the form of a drop, its diameter is limited to 2-15 mm and its thickness is limited to 0.1-0.5 mm or 0.7-1.5 mm depending on the manufacturing process used. Furthermore the jellified coating contains multivalent ions which when in excess contribute to the phenomenon of syneresis. In order to avoid this problem, a multivalent-ion sequestrant is necessary in the jellified coating.

Moreover, this product can not be obtained by the one-shot technology, since without the use of such a source of outside calcium ions, the gel is not formed. As a consequence the final product will be glued to the mould.

Finally, the manufacture processes describe in U.S. Pat. No. 6,627,236 are very long since the product obtained need to be rinsed and dried before use.

Surprisingly the present inventors have found a way to manufacture fresh dairy product having an external jellified coating by the one-shot technology. Furthermore the fresh dairy product having an external jellified coating according to the present invention does not have the drawbacks of the prior-art and can present different 2D or 3D forms.

According to one aspect, the invention provides a fresh food product comprising a temperature-dependent external jellified coating and an internal filling comprising a dairy product which is completely enclosed in the external jellified coating.

According to the present invention, a fresh food product is intended to mean any food product having a storage temperature of between 1 and 10° C., more advantageously of between 3 and 8° C.

Advantageously, the fresh food product according to the present invention has a shelf life of at least 4 weeks at the storage temperature, advantageously of 4-6 weeks at the storage temperature.

According to the present invention, the gel of the jellified coating is temperature-dependent. Therefore such a gel is build up by temperature reduction. Advantageously, the gel will be destroyed by a temperature at least superior to the jellification temperature. As a consequence, the gel exists only at a temperature of below 20° C., more advantageously, of below 15° C. and still more advantageously of below 11° C. As a consequence the structure of the gel is different from a gel obtained by reaction with multi-valent ions. In this latter case, the gel obtained is not temperature-dependent but is ionic dependent.

The gel according to the present invention is not ionic dependent.

Advantageously, the external jellified coating of the fresh food product according to the present invention has a thickness of 2 to 15 mm.

In a preferred embodiment, the external jellified coating of the present invention comprises fruits juice, water and/or milk ingredients.

In a very preferred embodiment, the external jellified coating of the present invention comprises at least fruits juice. According to the present invention, the fruits juice is in a natural form or a concentrate form or in powder form.

Fruits according the present invention can be chosen for example between orange, mandarin, grapefruit, lemon, rhubarb, plum, grape, mango, passion fruit, pineapple, coconut, peach, apricot, pear, apple, melon, watermelon, kiwi, carrot, red fruit as raspberry, cranberries, strawberry, blueberry, blackberry, cherry, redcurrants or whortleberry.

Moreover, according to the present invention, the fruits juice can be based on one or several fruits.

In a preferred embodiment, the external jellified coating comprises at least one gelling agent which forms a temperature-dependent gel, i.e. which forms a gel by temperature reduction. Advantageously the external jellified coating comprises a combination of gelling agents in which one of the gelling agent forms a gel by temperature reduction. More advantageously, all the gelling agents of the combination of gelling agents form a gel by temperature reduction. Still more advantageously the gelling agent is not reactive with multi-valent ions. Advantageously, the external jellified coating does not contain any gelling agent which is reactive with multi-valent ions.

The gelling agent according to the present invention is chosen among of the following gelling agents:
E406 Agar
E407 Carrageenan
E407a Processed eucheuma seaweed
E410 Locust bean gum (Carob gum)
E412 Guar gum
E413 Tragacanth
E414 Acacia gum
E415 Xanthan gum
E416 Karaya gum
E417 Tara gum
E418 Gellan gum
E425 Konjac (i) Konjac gum (ii) Konjac glucomannane
E441 Gelatine
E461 Methylcellulose

The number E4XXX is referring to food additive codes usually used for food product labels in the European Union.

The gelling agent according to the present invention is preferably chosen between agar, gellan, carrageenan and gelatine, more advantageously between agar, carrageenan and gelatine. Advantageously the gellan used is not a weakly acetylated gellan.

Constituents forming the external jellified coating before jellifying can be powders (for example gelling agents, sugar, milk powder, fat powder, acid powder) diluted in liquid as for example water, fruits juice, milk ingredients. Milk ingredients are in particular milk, cream, yoghurt or their mixture.

The external jellified coating has to show good microbiologically stability during shelf life, and particularly avoid problem of water migration.

To obtain a good microbiologically stability the external jellified coating product according to the present invention has preferably a water activity below 0.9. Preferably, the external jellified coating has a water activity between 0.5 and 0.85, and more preferably of 0.80.

Moreover, to obtain a good microbiologically stability, the external jellified coating product according to the present invention has a pH below 7. Preferably, the external jellified coating has a pH between 2 to 5 and more preferably 3.

In the fresh food product according to the present invention, the internal filling comprises a dairy product. The dairy product is a fresh dairy product.

In a particular embodiment of the present invention, the fresh dairy product is a fermented dairy product, an unfermented dairy product or a mixture of both (such as milk and fermented yoghurt powder).

By the term “fermented dairy product”, is intended to mean more particularly any fermented dairy product ready for the human consumption, i.e. any food dairy product.

In the present application fermented milk and yoghurt are particularly contemplated. Alternatively, the fermented dairy food can be cottage cheese or fresh cheese such as so called <<petits suisses>>.

The terms “fermented milk” and “yoghurt” have the conventional meaning in the area of dairy industry, i.e. products which are intended for human consumption and which are obtained by lactic fermentation of a milk substrate. These products can contain other ingredients such as fruits or sugar. For example see the French act n^{o}88-1203 of Dec. 30, 1988 on fermented milk and yoghurt, published in the Official Journal of the French republic on Dec. 31, 1988. See also the “Codex Alimentarius>> (prepared by the Commission of the Codex Alimentarius and published by the Information Division of the FAO, available on line on http://www.codexalimentarius.net; more particularly the volume n^{o}12 of the Codex Alimentarius <<Codex standard for milk and milk products”, and the standard “CODEX STAN A-1 1(a)-1975”).

In a preferred embodiment, the internal filling according to the present invention is in liquid or semi-liquid form.

The semi-liquid form according to the present invention is an intermediary state between liquid form and solid form, and has the characteristic to be pumpable.

In particular the internal filling must be liquid during dosing, i.e. at the dosage temperature.

Constituents forming the internal filling can be powders (for example milk powder) diluted in liquids as for example water, milk, cream and/or yoghurt.

According to the present invention, constituents forming the external coating are gelling agent, water, sweetening agents chosen for example between dextrose, fructose, saccharose, fruit juice concentrate, sweetener and bulking agents chosen for example between milk or milk products, fat powder, fibre, acid, fruit or fruit preparation and flavour.

The possible range for each constituent of the external jellified coating according to the present invention is shown in table 1, with two examples of formula A and B.

TABLE 1
Formula of the external jellified coating.

| | | +Range: | Example A: | Example B: |
|---|---|---|---|---|
| Ingredient: | Possibilities: | [%] | [%] | [%] |
| Gelling agents | | 0.2-5.0 | | |
| | agar | 1.5-5.0 | | 2.0 |
| | gellan | 0.2-1.5 | 1.0 | |
| | carrageenan | 1.5-5.0 | | |
| | gelatine | 3-12 | | |
| Water | | Ad to 100 | 43.8 | 68.7 |
| Sweetening | | 1.0-41.0 | | |
| agents | | | | |
| | dextrose | 0-4.0 | | |
| | fructose | 0-10.0 | | |
| | saccharose | 0-40.0 | | |
| | fruit juice | 1.0-50.0 | 40.0 | 19.0 |
| | concentrate | | | |
| | sweetener | 0-1.0 | | |
| Bulking | | | | |
| agents | | | | |
| | milk or milk | 0-20.0 | 12.0 | 9.0 |
| | products | | | |
| | powder | | | |
| | fat powder | 0-10.0 | | |
| | fibre | 0-10.0 | | |
| | acid (powder) | 0-5.0 | 1.5 | 0.3 |
| | fruit or fruit | 0-20.0 | 1.7 | 1.0 |
| | preparation | | (powder) | (powder) |
| | flavour | 0-2.0 | | |

In a preferred embodiment, the fresh food product according to the present invention is in a spherical 3-D form depending on the used moulds or blister. According to the present invention the term “ball” can be used to define the shape of the food product. But according to the present invention, the fresh food product could be in other forms like fruits form (for example strawberry as in FIG. 4) or bar form. FIG. 4 shows pictures of moulds or blisters useable for one-shot technology and examples of shapes obtainable by this technology.

Advantageously, the average diameter of the fresh food product according to the present invention is of between 1.5 and 5 cm, more advantageously of between 2 and 5 cm, still more advantageously of between 2 and 2.5 cm.

According to one aspect, the invention provides a process for the manufacture of a fresh food product according to the present invention, this process comprising the following steps:

1. the constituent forming the external jellified coating, this constituent being at a temperature greater than its gelling temperature, and the constituent forming the internal filling are simultaneously metered and simultaneously introduced into an intermediate mould or a final packaging and,
2. the said constituents are cooled to a temperature of less than the gelling temperature of the constituent forming the external jellified coating.

Only the temperature of the external jellified coating has to be higher than the gelling temperature; the temperature of the internal filling depends on the viscosity and should be for easier handling in the range of the temperature of the external coating. However, advantageously the temperature of the internal filling is such that the internal filling is fluid during the dosing.

FIG. 2 shows an example of process according to the present invention where

1. Constituents (powder and liquid) forming the internal filling are mixed, heated, cooled and tempered in a storage tank.
2. Constituents forming the external jellified coating are stored in a storage tank and then moved to a tempering machine.
3. Constituents forming the external jellified coating, these constituents being at a temperature greater than their gelling temperatures and constituents forming the internal filling are simultaneously introduced in a one shot machine to be simultaneously metered and simultaneously introduced into an intermediate mould or a final packaging and
4. Products obtained are moved in a cooling tunnel to be cooled to a temperature of less than the gelling temperature of the constituent forming the external jellified coating, and packaged. The cooling step lasts advantageously from 2 to 15 min.

The first step of the process according to the present invention consisting of simultaneously metered and simultaneously introduced the constituent forming the external jellified coating, this constituent being at a temperature greater than its gelling temperature, and the constituent forming the internal filling into an intermediate mould or a final packaging, is done by one-shot technology. In the one-shot process, only one step is enough to get a final product. The co-extrusion of the one shot system takes place in moulds, which allow a big variation of shapes.

FIG. 1 shows the one shot process, with the 8 stages: 1) intake, 2) positioning moulds, 3) lower, 4) operate the rotary valves, 5) pre-dose, 6) dosing, 7) redose, and 8) drive up.

In a preferred embodiment, the simultaneous metering and the simultaneous introduction into the intermediate mould or the final packaging of the constituents in the first step of the process according to the present invention are carried out at a temperature between 25 and 75° C. This temperature will depend on the gel properties.

In a preferred embodiment, the cooling temperature in the second step of the process according to the present invention is between −196° C. (for example with liquid nitrogen) and 15° C. and preferably between 0 and 15° C. and more preferably between 3 and 8° C.

In a preferred embodiment, constituents forming the internal filling are a) mixed, b) heated, c) cooled and d) tempered at a temperature between 25 and 50° C., before metered with the constituent forming the external jellified coating.

In a preferred embodiment, constituents forming the internal filling are heated at a temperature between 75 and 90° C.

In a preferred embodiment, constituents forming the internal filling are cooled at a temperature between 3 and 10° C.

In a preferred embodiment, constituents forming the internal filling are a) mixed, b) heated at a temperature between 75 and 90° C., cooled at a temperature between 3 and 10° C. and d) tempered at a temperature between 25 and 50° C., before metered with the constituent forming the external jellified coating.

In a preferred embodiment, constituents forming the external jellified coating according to the present invention are heated and tempered before metered with the constituents forming the internal filling.

More particularly, a process to obtain constituents forming the external jellified coating in a liquid form, before metering with internal filling is shown in FIG. 3:

a) liquids and powders are mixed 2 minutes at a temperature of 20° C.
b) the mix obtained in step a) is hydrated 10 minutes at a temperature of 20° C.
c) the mix obtained in step b) is heated, for pasteurization, 2 to 10 minutes at a temperature between 70 and 100° C., or for sterilization, 0 to 60 seconds at a temperature between 125 and 140° C.
d) the mix obtained in step c) is cooled to a temperature between 50 and 70° C.
e) flavours and fruits are added to the mix obtained in step d) at a temperature between 50 and 70° C. in 2 minutes
f) the mix obtained in step e) is tempered at a temperature between 30 and 100° C. depending to the gel properties.

Moreover, constituents forming the external jellified coating are heated in order to obtain a viscosity between 40 and 3500 mPas. This viscosity can be obtained by heating constituents forming the external jellified coating at a temperature between 30 and 100° C.

For the gel coating, different process of heating could be used: pasteurization (70-100° C.) and sterilization (125-140° C.). The speed of mixing is depending on the technology, which is used for the gel preparation.

Particularly,

a. if the gelling agent of the external jellified coating is agar, the temperature of heating is comprised between 38 and 52° C. in order to obtain a viscosity between 1000 and 3500 mPas,
b. if the gelling agent of the external jellified coating is gellan, the temperature of heating is comprised between 50 and 65° C. in order to obtain a viscosity between 800 and 3500 mPas and
c. if the gelling agent of the external jellified coating is carrageenan, the temperature of heating is comprised between 61 and 75° C. in order to obtain a viscosity between 40 and 1000 mPas.

Moreover, according to the present invention the internal filling is preferably in liquid form during step 1 of the process.

More preferably, the viscosity of the hot internal filling in the hopper is between 0 and 3500 mPas (milliPascal/second), preferably between 1000 and 3500 mPas.

Advantageously, the overall process lasts 60 min at most.

Table 2, 3 and 4 respectively show the possible range and best solution tested of process parameters according the present invention for preparation of food product with agar, gellan or carrageenan as gelling agent in the external jellified coating.

TABLE 2
Process parameters for preparation of food product with
agar as gelling agent in the external jellified coating.

| | | | | Best solution |
|---|---|---|---|---|
| Parameter: | Description: | Unit: | Range: | tested: |
| Dry matter | gel | % | 25-65 | 49 |
| | filling | % | 35-75 | 51 |
| Temperature | gel storage | ° C. | 38-52 | 41 |
| | hopper | | | |
| | gel mould | ° C. | 35-50 | 38 |
| | gel after | ° C. | 5-15 | 10 |
| | cooling (30 | | | |
| | min) | | | |
| | filling storage | ° C. | 30-50 | 37 |
| | hopper | | | |
| | cooling tunnel | ° C. | 3-8 | 6 |
| Viscosity | gel storage | mPas | 1000-3500 | 1800 ± 100 |
| | hopper | | | |
| (Rheomat 64 1/s; | gel mould | mPas | 1500-4000 | 2100 ± 100 |
| 10 s; 22) | | | | |
| | filling storage | mPas | 1000-3500 | 1900 ± 100 |
| | hopper | | | |
| Stability | gel (10° C.) | g | 2000-4000 | 3300 ± 100 |
| (Texture Analyser | filling (10° C.) | g | 20-1000 | 50 ± 5 |
| TAXT2) | | | | |

TABLE 3
Process parameters for preparation of food product with gellan
as gelling agent in the external jellified coating.

| | | | | Best solution |
|---|---|---|---|---|
| Parameter: | Description: | Unit: | Range: | tested: |
| Dry matter | gel | % | 25-65 | 49 |
| | filling | % | 35-75 | 51 |
| Temperature | gel storage | ° C. | 50-65 | 52 |
| | hopper | | | |
| | gel mould | ° C. | 47-62 | 49 |
| | gel after | ° C. | 5-15 | 10 |
| | cooling (30 | | | |
| | min) | | | |
| | filling storage | ° C. | 30-50 | 37 |
| | hopper | | | |
| | cooling tunnel | ° C. | 3-8 | 6 |
| Viscosity | gel storage | mPas | 800-3500 | 1200 ± 500 |
| | hopper | | | |
| (Rheomat 64 1/s; | gel mould | mPas | 1200-4000 | 1500 ± 500 |
| 10 s; 22) | | | | |
| | filling storage | mPas | 1000-3500 | 1900 ± 100 |
| | hopper | | | |
| Stability | gel (10° C.) | g | 800-4000 | 2000 ± 100 |
| (Texture Analyser | filling (10° C.) | g | 20-1000 | 50 ± 5 |
| TAXT2) | | | | |

TABLE 4
Process parameters for preparation of food product with carrageenan
as gelling agent in the external jellified coating.

| | | | | Best solution |
|---|---|---|---|---|
| Parameter: | Description: | Unit: | Range: | tested: |
| Dry matter | gel | % | 25-65 | 49 |
| | Filling | % | 35-75 | 51 |
| Temperature | gel storage | ° C. | 61-75 | 63 |
| | hopper | | | |
| | gel mould | ° C. | 59-73 | 60 |
| | gel after | ° C. | 5-15 | 10 |
| | cooling (30 | | | |
| | min) | | | |
| | filling storage | ° C. | 30-50 | 37 |
| | hopper | | | |
| | cooling tunnel | ° C. | 3-8 | 6 |
| Viscosity | gel storage | mPas | 40-1000 | 500 ± 50 |
| | hopper | | | |
| (Rheomat 64 1/s; | gel mould | mPas | 40-1000 | 600 ± 50 |
| 10 s; 22) | | | | |
| | filling storage | mPas | 1000-3500 | 1900 ± 100 |
| | hopper | | | |
| Stability | gel (10° C.) | g | 500-3000 | 1800 ± 100 |
| (Texture Analyser | filling (10° C.) | g | 20-1000 | 50 ± 5 |
| TAXT2) | | | | |

### BRIEF DESCRIPTION OF THE DRAWINGS

FIG. 1: Step one of the process according to claim 10: one shot process, with the 8 stages: 1) intake, 2) positioning moulds, 3) lower, 4) operate the rotary valves, 5) pre-dose, 6) dosing, 7) redoes, and 8) drive up.

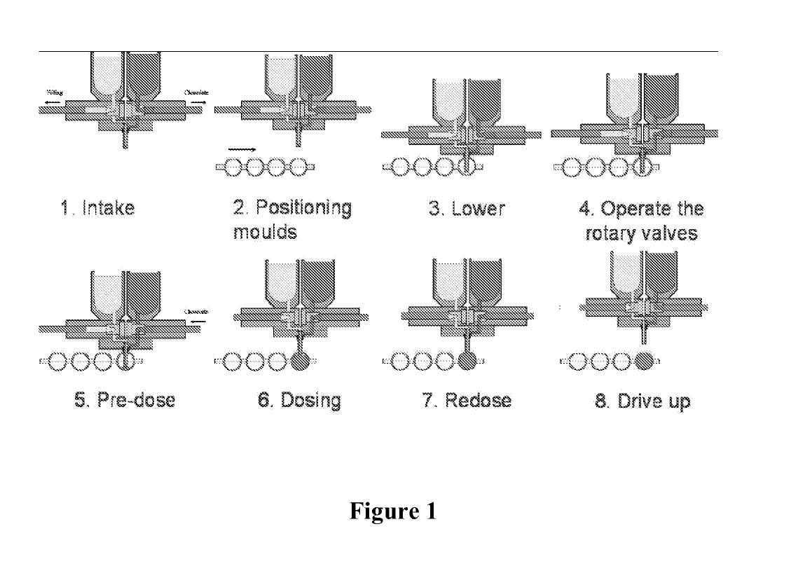

FIG. 2: Process for the manufacture of a food product according to claim 1.

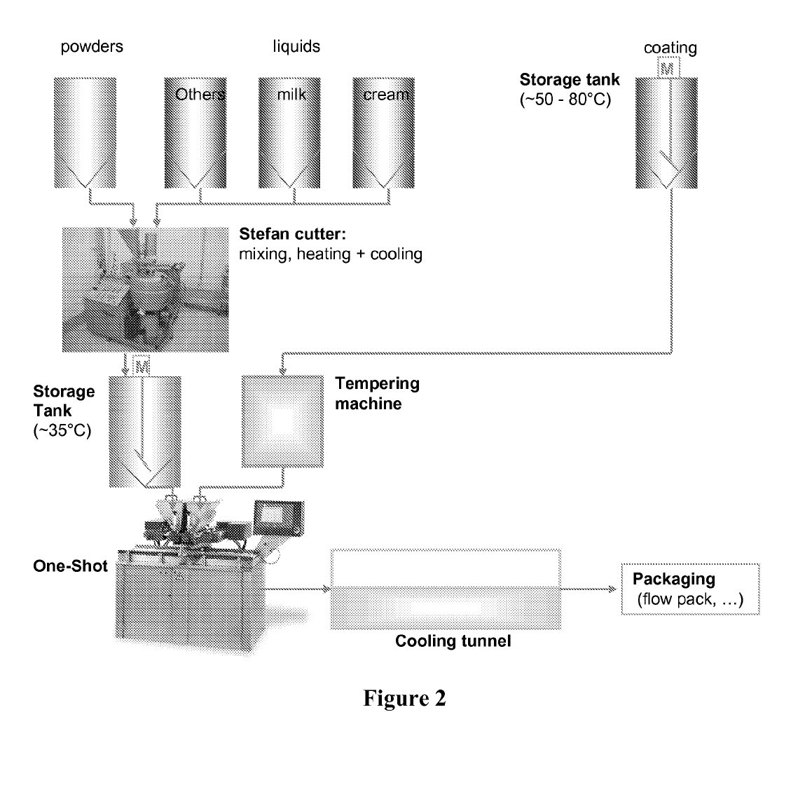

FIG. 3: Process to obtain constituents forming the external jellified coating in a liquid form, before metering with internal filling by using pasteurization process or by using sterilization process.

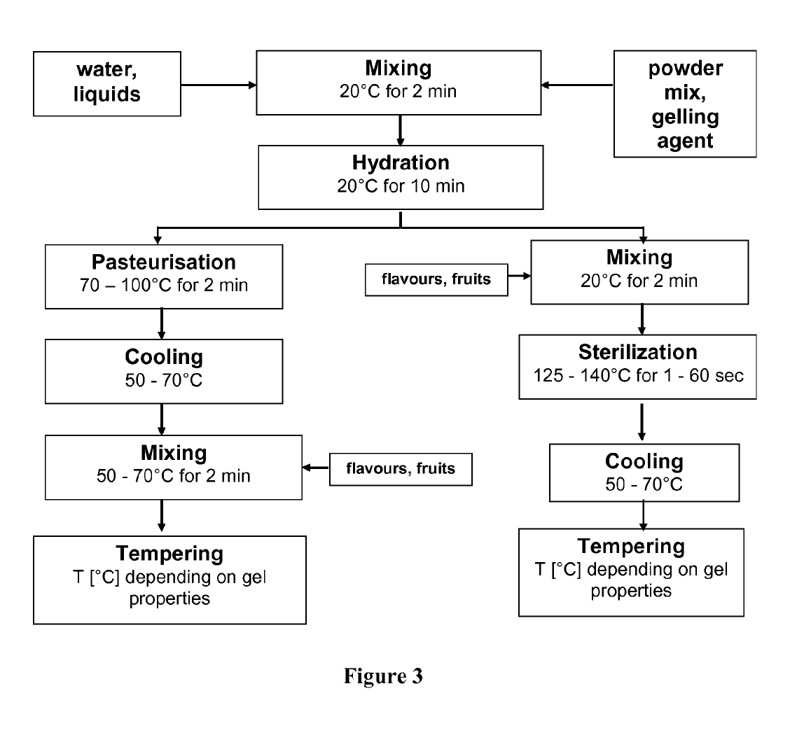

FIG. 4: Pictures of moulds or blisters useable for one-shot technology and shapes obtainable by this technology.

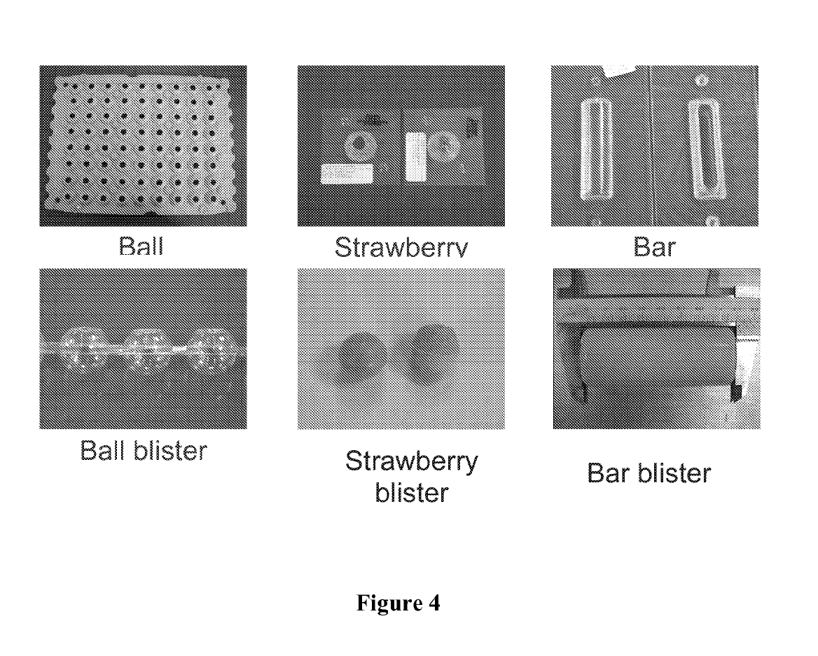

1. Fresh food product comprising an external temperature-dependent jellified coating and an internal filling comprising a dairy product which is completely enclosed in the external jellified coating.

2. Fresh food product according to claim 1, wherein the external jellified coating comprises fruits juice, water and/or milk ingredients.

3. Fresh food product according to claim 2, wherein the fruits juice is in a natural form or a concentrate form or in a powder form.

4. Fresh food product according to claim 1, wherein the external jellified coating comprises at least one, or a combination of, gelling agent.

5. Fresh food product according to claim 4, wherein the temperature-dependent gelling agent is chosen between agar, gellan, carrageenan and gelatine.

6. Fresh food product according to claim 1, wherein the external jellified coating has a water activity below 0.9.

7. Fresh food product according to claim 1, wherein the external jellified coating has a pH below 7.

8. Fresh food product according to claim 1 wherein the internal filling is in liquid or semi liquid form.

9. Fresh food product according to claim 1, wherein the food product is in a 2-D or 3-D form depending on the used moulds or blister.

10. Process for the manufacture of a food product according to claim 1 to this process comprising the following steps:
1) the constituent forming the external jellified coating, this constituent being at a temperature greater than its gelling temperature, and the constituent forming the internal filling are simultaneously metered and simultaneously introduced into an intermediate mould or a final packaging and,
2) the said constituents are cooled to a temperature of less than the gelling temperature of the constituent forming the external jellified coating.

11. Process according to claim 10, wherein the simultaneous metering and the simultaneous introduction into the intermediate mould or the final packaging of the constituents are carried out at a temperature between 25 and 75° C.

12. Process according to claim 10, wherein the cooling temperature is preferably between −196° C. and 15° C.

13. Process according to claim 10, wherein the constituents forming the internal filling are a) mixed, b) heated, c) cooled and d) tempered at a temperature between 25 and 50° C., before metered with the constituent forming the external jellified coating.

14. Process according to claim 10, wherein the constituents forming the external jellified coating are heated and tempered before metered with the constituents forming the internal filling.

15. Process according to claim 14, wherein the constituents forming the external jellified coating are heated in order to obtain a viscosity between 40 and 3500 mPas.

16. Process according to claim 15, wherein the constituents forming the external jellified coating are heated at a temperature between 30 and 100° C.

17. Process according to claim 14, wherein:
a) if the gelling agent of the external jellified coating is agar, the temperature of heating is comprised between 38 and 52° C. in order to obtain a viscosity between 1000 and 3500 mPas,
b) if the gelling agent of the external jellified coating is gellan, the temperature of heating is comprised between 50 and (5° C. in order to obtain a viscosity between 800 and 3500 mPas and
c) if the gelling agent of the external jellified coating is carrageenan, the temperature of heating is comprised between 61 and 75° C. in order to obtain a viscosity between 40 and 1000 mPas.

18. Process according to claim 10, wherein the internal filling is in liquid form during step 1.
